(19) United States
(12) Patent Application Publication
(10) Pub. No.: US 2004/0255053 A1
(43) Pub. Date: Dec. 16, 2004

(54) Information processing device and method for controlling the same

(76) Inventor: Byung-Suk Kang, Yongin-Si (KR)

Correspondence Address: CANTOR COLBURN LLP, 55 Griffin Road South, Bloomfield, CT, 06002, US

(21) Appl. No.: 10/867,971

(22) Filed: Jun. 14, 2004

(30) Foreign Application Priority Data
Jun. 16, 2003 (KR) 2003-38947
May 18, 2004 (KR) 2004-35373

(51) Int. Cl. G06F 3/00

(52) U.S. Cl. 710/1

(57) ABSTRACT

An information processing device adapted to a USB mass storage device, and a method for controlling the same. The USB (Universal Serial Bus) mass storage device including a memory and a memory controller equipped with Firmware, includes the memory. The memory includes a first memory area for storing a program accessible to a remote server, and being defined as an area whose data is not deleted by a user; a second memory area for storing corresponding information, and being defined as an area whose data is not deleted by the user; and a third memory area accessible by the user, which is defined as an area whose data is recorded or deleted by the user.

### BACKGROUND OF THE INVENTION

1. Field of the Invention

The present invention relates to an information processing device and a method for controlling the same, and more particularly to an information processing device applied to a USB (Universal Serial Bus) mass storage device, and a method for controlling the same.

2. Description of the Related Art

In the mid-1990s, the Intel Corporation and some enterprises have established a USB standard to improve I/O (Input/Output) speeds and functions of typical peripheral devices.

The USB standard has been established to allow a maximum of 127 peripheral devices to be connected to a computer. Representative peripheral devices for use with the USB standard are USB mouses, and USB keyboards, etc.

The USB has different transfer rates according to its standards. For example, the USB 1.1 standard provides the USB with a maximum transfer rate of 12 Mbps, and the USB 2.0 standard provides the USB with a maximum transfer rate of 480 Mbps.

Due to the diversity and extensibility of the USB standard, new peripheral devices other than the aforementioned peripheral devices have recently been developed and introduced to the market.

Particularly, the most popular USB-based peripheral device is a portable storage device for use with an HDD (Hard Disk Drive) or a flash memory. Typically, the portable storage device for use with the HDD is called a USB hard drive, and the other portable storage device for use with the flash memory is called a USB disk.

The USB hard drive has generally been used as an external storage device using an HDD for use in a notebook computer. However, this USB hard drive has very weak resistance to mechanical impact whereas it has high capacity and a palm-sized form.

Recently, a USB disk acting as a micro storage device for use with a flash memory has been introduced to the market. Although the USB disk is more expensive per megabyte than the old USB hard drive, it has a smaller size than the HDD, has very strong resistance to mechanical impact, and is able to implement a variety of functions, such that the USB disk is increasingly popular in the market.

If the price of flash memory comes down in the near future, high demand for USB disks is predicted, such that many developers are conducting intensive research into the USB disks.

The flash memory is constructed by integration of a ROM (Read Only Memory) with a RAM (Random Access Memory).

In more detail, the flash memory is a recordable and erasable storage medium, as is RAM, and has a unique characteristic in which data recorded in the flash memory is not erased from the flash memory even when the flash memory is not powered.

The flash memory has characteristics of both the RAM and the ROM, such that its data is maintained even when it does not receive a power-supply voltage.

Although a portable storage device using the flash memory has been called a flash disk or a USB drive by those skilled in the art, a generic name for the flash disk and the USB drive has not been established yet.

It should be noted that the portable storage device using the flash memory is called a USB disk in the present invention.

The fundamental concepts of the USB disk have been described in the Universal Serial Bus Mass Storage Class Specification Overview Version 1.0 prescribed by the USB Implementers Forum (hereinafter referred to as a USB-IF) on Oct. 22, 1998, which will hereinafter be called the “first reference”.

The first reference has simply described both the fundamental concepts of the USB disk and categories of a variety of external devices capable of employing the USB.

A more detailed description of the USB disk has been described in U.S. Pat. No. 6,148,354, which will hereinafter be called the “second reference”.

However, an unexpected problem has recently arisen in that an objection has been raised as to the validity of the second reference's patentability due to the patentability of the first reference proposed by the USB-IF.

If the fundamental concepts of the USB disk, prescribed in the USB-IF, are commercially possessed by a specific person or specific enterprise, it will be inconsistent with the purpose of establishing the USB standard because the USB standard has been established to promote public interest.

The principal components of the second reference are comprised of a USB connector, a controller, and a flash memory, and are the same as those of the first reference.

The first and second references confine their scopes to the implementation of a basic mass storage device connected to the USB, and a method for encrypting data stored in their memories or a method for realizing an algorithm adapted to improve processing speed are not described in the first and second references, such that other improved technologies may be newly proposed by the development of kernel and associated technologies.

The storage capacity of the USB disk using a flash memory is in the range of 8 Megabytes to 2 Gigabytes, and the USB disks including the storage capacity ranging from 8 Megabytes to 2 Gigabytes are actively being introduced to the market. In the future, it is expected that the storage capacity will increase to 4 or 8 Gigabytes.

### SUMMARY OF THE INVENTION

Therefore, the present invention has been made in view of the above problems, and it is an object of the present invention to provide an information processing device and method which allows a USB disk to automatically connect to a remote server when the USB disk is connected to a computer on the basis of the fundamental concepts of a typical USB disk, such that necessary information is communicated between the server and the USB disk.

The fundamental concepts of the present invention have been described in Korean Patent Application No. 10-2002-00300, which will hereinafter be called the “third reference”.

It is another object of the present invention to provide an information processing device and method which stores information communicated with the remote server in a specific area inside of the USB disk, prevents a user from viewing or erasing the information stored in the USB disk using Windows Explorer, etc., such that it can perform a variety of functions, for example, advertisement, external DB (DataBase) use of a Website, customer management, memory space use of specific software, and data security maintenance, etc.

In order to establish data communication between the USB disk and the remote server, an agent program (hereinafter referred to as an agent) and an ID (Identifier) code must be stored in the USB disk to allow the server to recognize data of the USB disk at a remote location.

In accordance with the third reference, the inventive method includes the steps of: a) allowing the USB disk to access a computer; b) transmitting a unique number stored in the USB disk to a server via the computer; c) allowing the server to recognize the unique number, and determining the presence or absence of data transmission qualification; and d) if the data transmission qualification is authenticated, allowing the server to transmit corresponding data to the USB disk.

Based on the fundamental concepts of the USB disk and the third reference, the present invention provides an improved approach to communication between the USB disk and the remote server, and implements improved products. The hard disk storage medium also has the characteristics of the ROM and the RAM in the same manner as in the flash memory, so that it may substitute for the flash memory of the present invention.

The present invention may be used when data received from the server is incapable of being sufficiently stored in the USB disk due to lack of flash memory capacity of the USB disk.

After important data transferred from the server is stored in the USB disk, the present invention may prevent a user from mistakenly or intentionally erasing the data from the USB disk.

Furthermore, the present invention records data transferred from the server in a specific area of the flash memory to prevent the user from searching for a position of the data, and does not display the data on a PC (Personal Computer) monitor even though the Explorer program is used so that data security can be maintained.

As stated above, if the USB disk is connected to the computer and the computer is connected to the remote server over a network, the USB disk can automatically communicate with the server without the user's recognition, and the user is unable to erase data communicated between the USB disk and the server, such that many more commercial uses of the present invention are highly expected.

For example, information or an advertisement of a specific enterprise is transmitted to the USB disk as soon as the USB disk gains access to the server, and the unique functions of the USB disk can be erased from the USB disk on the condition that the advertisement or information is displayed on the computer for a predetermined period of time.

The USB disk can receive all of the file formats implemented in a typical Web-browser from the server, so that it can implement the received file formats.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram of an information processing device in accordance with a preferred embodiment of the present invention;

FIG. 2 is a flow chart illustrating an information processing method in accordance with a preferred embodiment of the present invention;

FIG. 3 is a conceptual diagram illustrating a USB disk in accordance with a preferred embodiment of the present invention;

FIG. 4 is a detailed block diagram illustrating a flash memory controller in accordance with a preferred embodiment of the present invention;

FIG. 5 is an internal configuration illustrating a flash memory for use in the third reference filed by the same applicant as the present invention;

FIG. 6 is an internal configuration illustrating a flash memory in accordance with a preferred embodiment of the present invention;

FIG. 7 is a view illustrating information contents displayed on a computer screen in accordance with a preferred embodiment of the present invention; and

FIG. 8 is a block diagram illustrating an example in which the present invention is adapted to an MP3 player.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

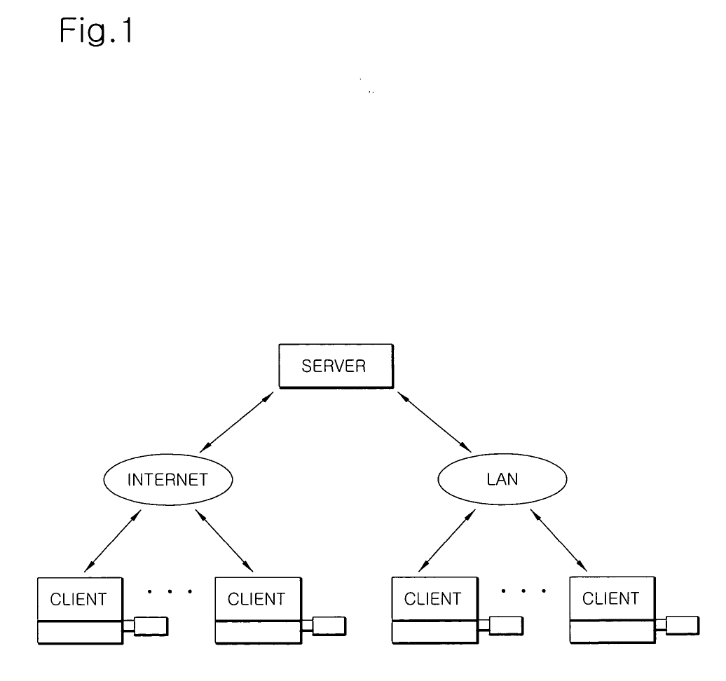

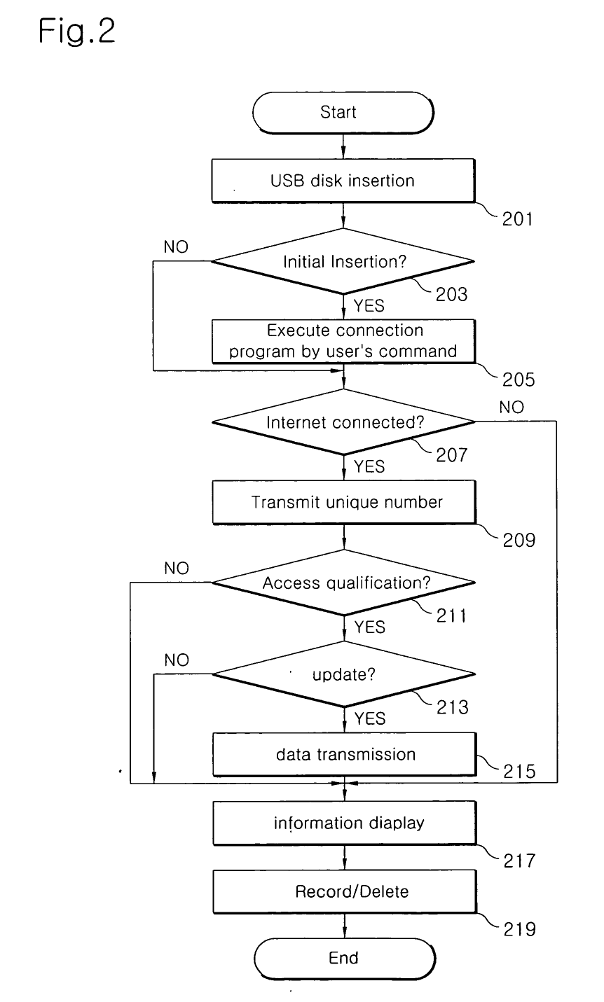

FIG. 1 is a conceptual diagram of an information processing device in accordance with a preferred embodiment of the present invention. FIG. 2 is a flow chart illustrating an information processing method in accordance with a preferred embodiment of the present invention.

Referring to FIG. 1, a server is connected to the Internet, and a large number of client computers are connected to the server over the Internet or a LAN (Local Area Network).

As can be seen from FIG. 2, the USB disk is connected to either one of the client computers at steps 201 and 203, an agent stored in the USB disk transmits a unique number or unique ID (Identifier) of the USB disk to the server over the client computer at step 209.

The remote server recognizes the unique number or unique ID of the USB disk, and determines the presence or absence of an access qualification at step 211, transmits necessary data to the client computer at step 215. The client computer transmits reception data to the USB disk, and stores it in the USB disk.

A method for recording the unique number in the USB disk and allowing the USB disk to communicate with the remote server has been described in the third reference filed by the same applicant as the present invention.

When accessing a USB port of the client computer after the USB disk is removed, data stored in the USB disk just before the access time is executed in the client computer.

The agent transmits the unique number to the server at step 209, and determines the presence or absence of data to be received later.

The remote server interacts with operations of the agent program, receives the unique number from the USB disk, and determines whether there is a need for data of the USB disk to be updated at step 213. If there is a need for data of the USB disk to be updated at step 213, the remote server transmits waiting-mode data to the client at step 215.

Needless to say, if a corresponding computer is not connected to the network at step 207, only old data is displayed at step 217.

A detailed description of the process shown in FIG. 2 will hereinafter be described.

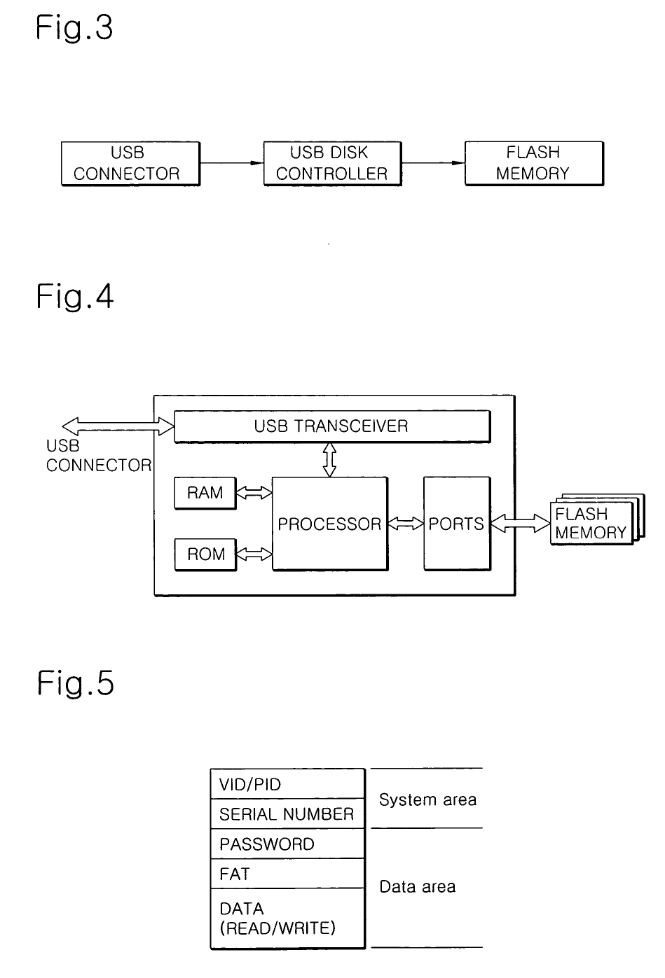

FIG. 3 is a conceptual diagram illustrating a USB disk in accordance with a preferred embodiment of the present invention.

Referring to FIG. 3, the USB disk is comprised of a USB connector, a USB disk controller, and a flash memory.

Firmware built into the USB disk controller interacts with a mass storage device class of the client computer, such that corresponding data can be recorded in the flash memory or erased from the same.

A file format created at a time of recording or erasing data in the flash memory follows a FAT (File Allocation Table) indicative of a representative file system of a typical Windows OS.

The flash memory is mostly classified into a NAND flash memory and a NOR flash memory. Although the USB disk mainly uses the NAND flash memory cheaper than the NOR flash memory, the NOR flash memory can also be utilized on the assumption that the cost of NOR flash memory decreases in the future.

Although the NAND flash memory is cheaper than the NOR flash memory, its data recording method is different from its data deletion method, such that its speed is slower than that of the NOR flash memory.

FIG. 4 is a detailed block diagram illustrating the USB disk controller of FIG. 3 in accordance with a preferred embodiment of the present invention.

Firmware is built into the ROM of the USB disk controller such that the USB disk is operable.

FIG. 5 is an internal configuration illustrating a flash memory for use in the third reference filed by the same applicant as the present invention.

As can be seen from FIG. 5, the memory is mainly comprised of a system area inaccessible by a user, and a data area in which data can be recorded or deleted.

A VID (Vendor ID) and a PID (Product ID) are included in the system area. The system area can establish data communication with the remote server, and includes a unique number to discriminate among individual USB disks.

The unique number is mainly built into the USB disk by a fabrication program at a time of fabricating the USB disk.

The data area includes a specific part for storing a password which prevents a third person from viewing data stored in the USB disk when the USB disk is lost, and also includes a FAT (File Allocation Table) for separating position and category information of the data.

As can be seen from FIG. 5, data downloaded from the server is recorded in the data area because there is no memory space.

However, the user can gain access to the data area so that data stored in the data area may be unexpectedly formatted by the user. If valuable data or data downloaded from the server should be deleted by the user, a variety of functions, for example, advertisement, external DB use of a Website, customer management, memory space use of specific software, and data security maintenance, etc., cannot be implemented.

In order to implement the aforementioned functions, the present invention prevents the user from deleting the unique number and downloaded data, and subdivides the area of the flash memory into many areas to make the user unaware of the presence or absence of data.

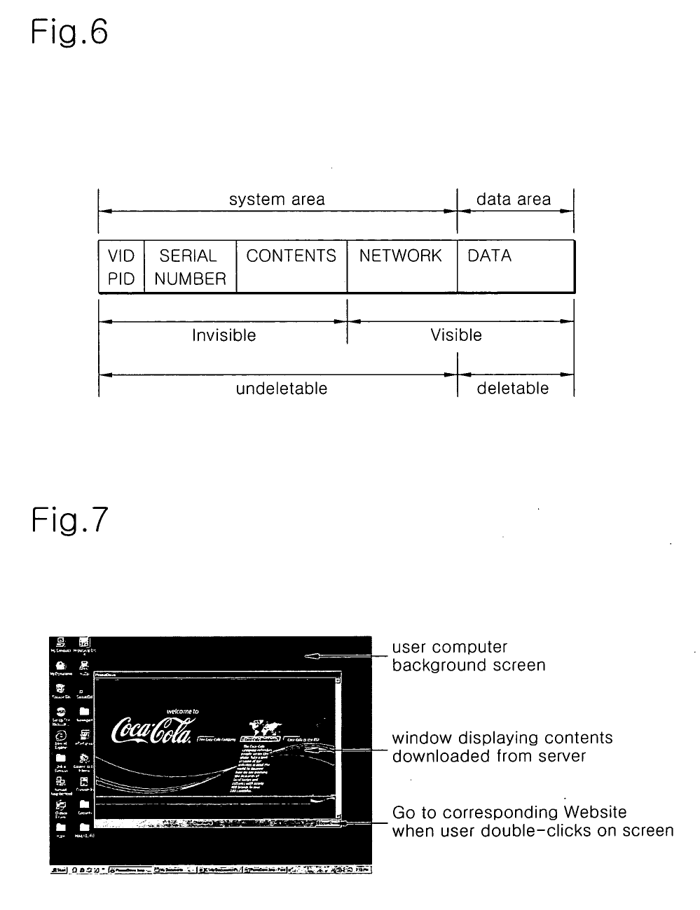

FIG. 6 is an internal configuration illustrating a flash memory in accordance with a preferred embodiment of the present invention.

It should be noted that the flash memory is constructed by an algorithm of Firmware built into the USB disk controller shown in FIG. 4.

The kernel of the present invention is schematically described in FIG. 6, and its detailed description will hereinafter be described with reference to FIG. 6.

Referring to FIG. 6, a flash memory of the present invention is comprised of a system area inaccessible by the user, and a data area to which the user is able to access so that the user can record or delete data in the data area.

Firstly, the system area will hereinafter be described.

VID is indicative of a company for manufacturing the USB disk, and PID is indicative of a product name. When the last user uses the flash memory, the VID and the PID can be recognized by a corresponding computer.

A serial number is indicative of an ID for identifying each of USB disks accessing the remote server. If necessary, individual IDs (e.g., individual customers) may be inserted in the system area. If there is a need for the USB disks to be grouped into one group, a Group Unique ID (e.g., an aggregate of customers) may also be inserted in the system area.

An area for storing data downloaded from the server is positioned next to the aforementioned ID information, and this area is called a contents area. The user is unable to delete data stored in the contents area, and is unable to identify data even in the case of checking data stored in the contents data. Therefore, category and name information of files stored in the contents area are not displayed on a computer screen even though the user uses the Windows Explorer program.

The magnitude of the contents area is adjustable by either Firmware of the USB disk controller or a fabrication program.

The contents area may store specific data prescribed at a time of fabricating the flash memory, or may download data from the server to update old data with new data.

A network area is positioned next to the contents area.

The network area includes an agent to establish data communication between the remote server and a corresponding USB disk.

Although the agent of the network area is visibly recognized by the user's eyes, the user is unable to remove the agent from the network area.

The agent is designed to be executed by the user.

In the meantime, a data area will be described.

The user can record or delete desired data in the data area.

The data area is indicative of a memory area operable like an HDD of a typical computer, such that its detailed description will herein be omitted for the convenience of description.

Operations of FIG. 2 will hereinafter be described with reference to FIG. 6.

The agent is stored in the network area.

If the USB disk is initially inserted in a corresponding computer at steps 201 and 203, the inserted USB disk is recognized as a mobile disk. After the mobile disk is recognized, the agent appears in the form of an execution command icon (not shown in FIG. 2).

If the agent does not receive an execution command from the user (i.e., if the agent is not double-clicked by the user), the user is unable to access the data area of the USB disk. In other words, the user is unable to perform the step 219 indicative of unique operations of the USB disk.

In more detail, the user is unable to record or delete data in/from the data area.

If the agent is executed by the user, data stored in the contents area is displayed on a computer screen at step 217. In this case, if a corresponding computer is not connected to the Internet at step 207 in the same manner as in FIG. 2, data pre-stored in the flash memory contents area is displayed on a computer screen at step 217. Otherwise, if the computer is connected to the Internet at step 207, a unique number of the flash memory is transmitted to the remote server at step 209. Upon receiving the unique number from the flash memory, the remote server determines the presence or absence of access qualification. If there is a need for data stored in the USB disk to be updated at step 213, corresponding data is transmitted to the client computer at step 215. Therefore, the data is stored in the flash memory contents area (not shown in FIG. 2).

The agent is installed in a corresponding computer, such that desired consecutive operations (i.e., steps 207 to 219) can be performed even though the agent is not executed in the same computer by the user at a later time (i.e., although the step 205 is omitted).

The USB disk is unable to perform an autorun mode as in a CD-ROM. Accordingly, if the agent is executed once at steps 203 and 205, the autorun effect of the USB disk can be attained. Technology for automatically installing a predetermined program of a USB peripheral device (e.g., a USB disk of the present invention) in a computer, and the other technology for controlling a computer OS to recognize the access of a specific USB peripheral device (e.g., a USB disk of the present invention) are well known to those skilled in the art prior to the application time of the present invention, such that they are obvious to those skilled in the art.

Data stored in the contents area may be displayed on a screen according to characteristics of information or advertisement which is pre-stored in a corresponding server and is to be transmitted to a target, and may automatically disappear from the screen after the lapse of a predetermined time.

The contents data is able to store or display all kinds of data expressed by the Windows Explorer program indicative of a representative Web-browser of Microsoft Corporation.

Because corresponding data is recorded in the contents area, although the USB disk is inserted in another computer other than a computer owned by a user, the user can attain the same effect desired by the user on the assumption that the aforementioned process is performed.

If there is no memory space in the USB disk because downloaded data is too large, the data may be stored in a specific area of a corresponding computer by the agent.

In this case, if the USB disk is executed in other computers other than the corresponding computer, it has no corresponding data, such that this data is incapable of being displayed on a screen.

FIG. 7 is a view illustrating information contents displayed on a computer screen in accordance with a preferred embodiment of the present invention.

In the meantime, as stated above, data can be recorded or removed in/from the flash memory (see step 219 in FIG. 2) after data stored in the flash memory contents area is displayed on a computer screen (see step 217 in FIG. 2). According to a preferred embodiment of the present invention, after data stored in the contents area is displayed (see step 217 in FIG. 2), corresponding contents (e.g., an MP3 file) equal to the displayed data are downloaded from the remote server, and the received data can be recorded in the data area of the flash memory (see step 219 in FIG. 2).

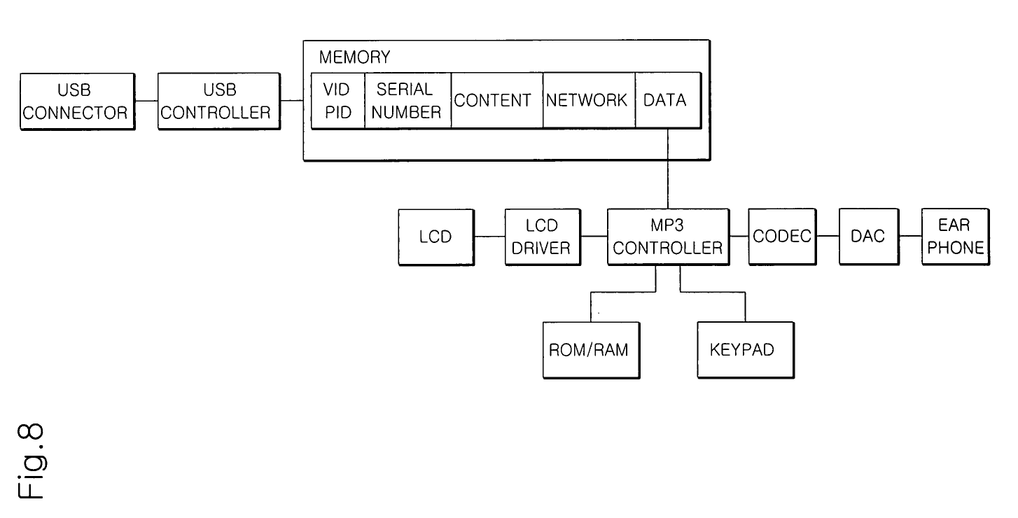

It is obvious that the present invention is applicable to the MP3 player. More specifically, a USB mass storage device comprised of a memory and a memory controller equipped with Firmware comprises components of the MP3 player as can be seen from FIG. 8. Upon receiving a user's command signal from a keypad, the MP3 controller access the data area of the memory to retrieve a desired MP3 file from the data area. CODEC (Coder-Decoder) decodes the MP3 file. DAC (Digital to Analog Converter) converts the decoded MP3 data into an analog signal, and outputs the converted signal to earphones. The MP3 controller outputs a current program running situation to an LCD (Liquid Crystal Display) over an LCD drive. ROM stores program data associated with operations of the MP3 controller, and RAM temporarily stores an MP3 file read for a play mode.

In the meantime, in accordance with a preferred embodiment of the present invention, the agent reads an ID recorded in an area (e.g., each system area in FIG. 5 or 6), whose data cannot be freely deleted by the user, from a memory area of a USB mass storage device, and the ID is transmitted to other programs executed by a computer connected to the USB mass storage device.

In accordance with a preferred embodiment of the present invention, other programs may be manufactured by program providers, and may be sold to one or more users. Other programs use the ID as authentication information, such that they can perform appropriate operations only when a corresponding USB mass storage device is connected to the user's computer. For example, the program providers may provide the user with both a CD (Compact Disk) storing a specific program and a USB mass storage device used as an authentication key.

In accordance with another preferred embodiment of the present invention, other programs may each be indicative of a program downloaded from a Website for providing a user PC with predetermined Web contents to the user PC. In the case of the Internet browser, such a program is equal to an ActiveX control program. The ActiveX control program uses the ID as authentication information, such that it can provide the user computer with the Website contents only when a corresponding USB mass storage device is connected to the user computer. For example, the Website for providing the user computer with the contents may provide the user with a USB mass storage device used as an authentication key.

### Industrial Applicability

As apparent from the above description, an information processing device of the present invention controls a USB disk to automatically access a server, and establishes data communication between the USB disk and the serve, such that it can be adapted as a new advertisement media terminal or a PDA (Personal Digital Assistant).

For example, when any Motors company (e.g., General Motors or Hyundai Motors, etc.) sells their motorcars to customers, an administrator or manager distributes an inventive USB disk of the present invention among the customers or a group of customers, such that the customers or the group of customers can view necessary information whenever the USB disk is inserted in their computers.

The server can recognize individual USB disks, and transmit necessary data to the USB disks, such that the information processing device of the present invention can be adapted as a new CRM (Customer Relation Management) device.

A customer DB is configured in the form of a huge Website, a large number of devices and a large number of experts are needed to construct the DB. The USB disk of the present invention is adapted as an external DB, such that the enterprise can greatly reduce production costs of the USB disk.

A pay Website sells the inventive USB disk to users instead of assessing charges to users using credit cards or mobile phones on the Internet, and allows its server to use a unique ID of the USB disk, resulting in CRM implementation.

In this case, a user ID of the pay Website cannot be shared in different areas, and can be accessed by the USB disk, such that management costs can be greatly reduced and additional costs needed for the shared ID can also be reduced.

High-priced software is pre-stored in the contents area, such that it can be operable when the USB disk is inserted in the inventive device if needed.

Furthermore, memory space inaccessible by a user and a unique ID are contained in the USB disk, such that many applications of the present invention will be expected in a variety of network-associated fields. The present invention implements the USB mass storage device with an exemplary USB disk for use with a flash memory. However, provided that the flash memory is replaced with an HDD, those skilled in the art will adapt the present invention to a portable HDD using a USB without departing from the scope and spirit of the invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A USB (Universal Serial Bus) mass storage device including a memory and a memory controller equipped with Firmware, comprising:
the memory including:
a first memory area for storing a program accessible to a remote server, and being defined as an area whose data is not deleted by a user;
a second memory area for storing corresponding information, and being defined as an area whose data is not deleted by the user; and
a third memory area accessible by the user, which is defined as an area whose data is recorded or deleted by the user.

2. The USB mass storage device apparatus according to claim 1, wherein the information stored in the second memory area is downloaded from the remote server using the program or is stored at a time of fabricating the USB mass storage device.

3. The USB mass storage device according to claim 1, wherein, if the program is executed, a computer connected to the USB mass storage device displays the information stored in the second memory on a screen.

4. The USB mass storage device according to claim 1, wherein the third memory area is accessible by the user only when the information stored in the second memory area is displayed on a computer connected to the USB mass storage device.

5. The USB mass storage device according to claim 1, wherein the program is installed in a computer connected to the USB mass storage device when the program is initially executed once in the computer, and is automatically executed when a USB external storage device is connected to the same computer so that it gains access to the remote server.

6. The USB mass storage device according to claim 1, wherein the program prevents file name and category information of the information stored in the second memory area from being displayed on an Explorer program of a computer.

7. The USB mass storage device according to claim 1, wherein the program stores corresponding contents downloaded from the remote server in the third memory area when the information stored in the second memory is displayed on a computer connected to the USB mass storage device.

8. The USB mass storage device according to claim 1, wherein the memory of the USB mass storage device is indicative of a flash memory.

9. The USB mass storage device according to claim 1, wherein the memory of the USB mass storage device is indicative of an HDD (Hard Disk Drive).

10. The USB mass storage device according to claim 1, wherein:
the memory further includes a fourth memory area for storing an ID of the USB mass storage device, and being defined as an area whose data is not deleted by the user, and
the program transmits the ID to another program executed in a computer connected to the USB mass storage device.

11. A method for providing information using a USB (Universal Serial Bus) mass storage device including a memory and a memory controller, comprising the steps of:
a) determining whether the USB mass storage device is connected to a USB port of a computer; and
b) displaying information stored in a memory area, which is positioned in the USB mass storage device and is defined as an area whose data is not deleted by a user, on the computer.

12. The method according to claim 11, further comprising the steps of:
c) reading an ID (Identifier) recorded in the area whose data is not deleted by the user from a memory area of the USB mass storage device, and transmitting the read ID to a remote server; and
d) if access qualification is authenticated by the ID, receiving information from the remote server, and storing the received information in the area whose data is not deleted by the user in the memory area of the USB mass storage device.

13. The method according to claim 11, further comprising the step of:
e) after performing the step (b) for displaying the information stored in the memory area, controlling a specific area, whose data is recorded or deleted by the user, contained in the memory area of the USB mass storage device so that the specific area becomes accessible.

14. The method according to claim 11, further comprising the step of:
f) if the information stored in the memory area whose data is not deleted by the user on a computer connected to the USB mass storage device, storing corresponding contents downloaded from the remote server in a memory area whose data is recorded or deleted by the user.

15. The method according to claim 11, wherein the memory of the USB mass storage device is indicative of a flash memory.

16. The method according to claim 11, wherein the memory of the USB mass storage device is indicative of an HDD (Hard Disk Drive).

17. The method according to claim 11, further comprising the step of:
g) reading an ID (Identifier) recorded in the area whose data is not deleted by the user from a memory area of the USB mass storage device, and transmitting the read ID to another program executed in a computer connected to the USB mass storage device.

18. The method according to claim 12, further comprising the step of:
e) after performing the step (b) for displaying the information stored in the memory area, controlling a specific area, whose data is recorded or deleted by the user, contained in the memory area of the USB mass storage device so that the specific area becomes accessible.
